(19) United States
(12) Patent Application Publication
(10) Pub. No.: US 2020/0400827 A1
(43) Pub. Date: Dec. 24, 2020

(54) LASER DETECTING DEVICE

(71) Applicants: Interface Technology (ChengDu) Co., Ltd., ChengDu (CN); INTERFACE OPTOELECTRONICS (SHENZHEN) CO., LTD., Shenzhen (CN); GENERAL INTERFACE SOLUTION LIMITED, Zhunan (TW)

(72) Inventors: MING-YANG PAN, Zhunan (TW); CHI-WEN HUANG, Kaohsiung (TW); CHIA-CHU LIN, Zhunan (TW)

(21) Appl. No.: 16/744,298

(22) Filed: Jan. 16, 2020

(30) Foreign Application Priority Data
Jun. 24, 2019 (CN) 201910548710.0

(51) Int. Cl. G01S 17/89; G01S 7/481; G02B 26/10; G02B 26/08

(52) U.S. Cl. CPC G01S 17/89; G02B 26/0808; G02B 26/10; G01S 7/4817

(57) ABSTRACT

A laser detecting device able to detect and map all the contours a target object can configure and apply at least two scanning point groups on the target object. Each scanning point group includes at least two scanning points. The laser detecting device includes four light sources at different angles of incidence in relation to a diffracting element. A beam receiving element receives all the light reflected by the target object, and a central controller records emitting and receiving times of the light emitted and received. The detection beams sequentially scan the at least two scanning point groups as the central controller switches on in turn one of the four light sources as the others are powered off. Processing of data from the beam receiving element enables a three-dimensional image of the target object to be obtained.

### FIELD

The subject matter herein generally relates to a field of three-dimensional image detecting, particularly relates to a laser detecting device.

### BACKGROUND

Depth sensing technology based on laser detection is widely used in terrain depiction, three-dimensional object scanning, and driverless driving. Laser detecting systems can be divided into two types that are flash laser detecting systems and scanning laser detecting systems.

The flash laser detecting system mainly includes a light module and a time-of-flight (ToF) array detector. The light module emits a burst of pulsed light to an object to be detected, and the object reflects the pulsed light to form an image on the array detector. The array detector defines a plurality of pixels, and a distance between each point of the object and the laser detecting system is detected according to a time for each pixel to detect the reflected light, thus a spatial depth image can be obtained. The scanning laser detection system can be regarded as a point-scanning laser range detector. The scanning laser detection system mainly includes a light module, a space scanning module, and a single time-of-flight detector. The light module uses a laser light source, which emits pulsed light to an object to be detected, and uses the single time-of-flight detector to receive the light reflected from the object, and detects a distance between each point of the object to be detected and the laser detection system according to received time of the reflected light. The space scanning module is configured to mount the laser light source, so that the pulse light emitted by the laser light source can be emitted into the space at different angles, thereby obtaining a spatial depth image.

### BRIEF DESCRIPTION OF THE DRAWINGS

Implementations of the present technology will now be described, by way of embodiment, with reference to the attached figures.

FIG. 1 is a schematic view showing a laser detecting device of a first embodiment.

FIG. 2 is a plan view of a diffracting element of the laser detecting device of FIG. 1.

FIG. 3 is a plan view showing a diffraction unit of FIG. 2.

FIG. 4 is a schematic view showing a spatial angular distribution of a detection beam emitted by the diffracting element of FIG. 2.

FIG. 5 is a plan view of a beam receiver of the laser detecting device of FIG. 1.

FIG. 6 is a plan view of a target object.

FIG. 7 is a schematic view showing a laser detecting device of a second embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

### First Embodiment

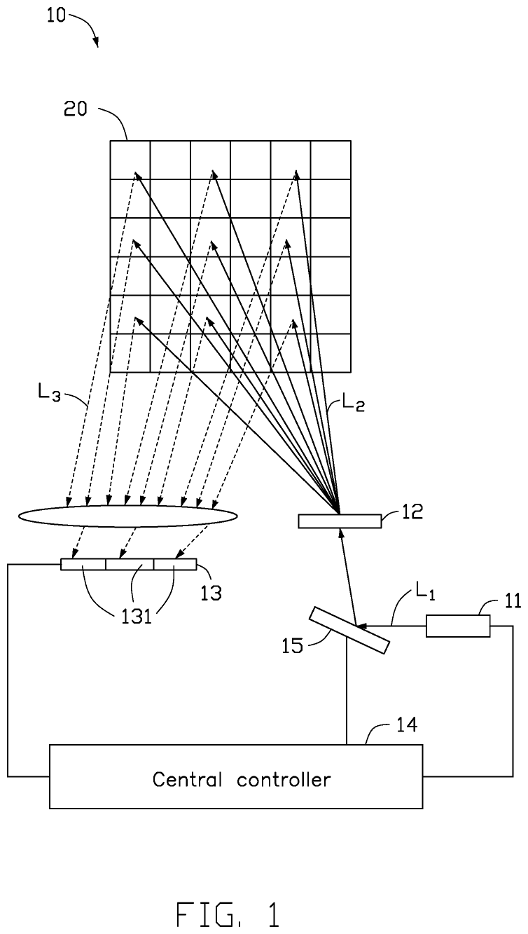

As shown in FIG. 1, a laser detecting device 10 of the first embodiment is configured to create an image of a target object 20 in an environment, and specifically, to create a three-dimensional image of the target object 20.

The laser detecting device 10 includes a light source 11, a diffracting element 12, a beam receiving element 13, and a central controller 14 connecting the light source 11 and the beam receiving element 13.

Referring to FIG. 1, the light source 11 is configured for emitting light L₁, and the light source 11 includes at least one laser (not shown) for emitting laser beams as the light L1. When the light source 11 includes a plurality of lasers, the laser beams can all be aimed in same direction. The number of lasers included in the light source 11 mainly affects a size of a spot when the light L₁ is striking the diffracting element 12, thereby affecting a spot formed on the target object 20 when a plurality of detection beams L2 from the diffracting element 12 is irradiating the target object 20. Therefore, the number of lasers included in the light source 11 can be set according to factors such as an area of the diffracting element 12, a size of the target object 20, and the like.

Referring to FIG. 1, the diffracting element 12 is located on an optical path of the light L₁, and the diffracting element 12 diffracts the light L₁ which it receives, for generating and emitting a plurality of detection beams L₂. The detection beams L₂ are used to scan the target object 20. In other words, the detection beams L₂ are used to irradiate the target object 20. When the detection beam L₂ scans the target object 20, the detection beam L₂ is reflected by the target object 20 to form reflected light beams L3 that correspond one-to-one with the detection beams L₂.

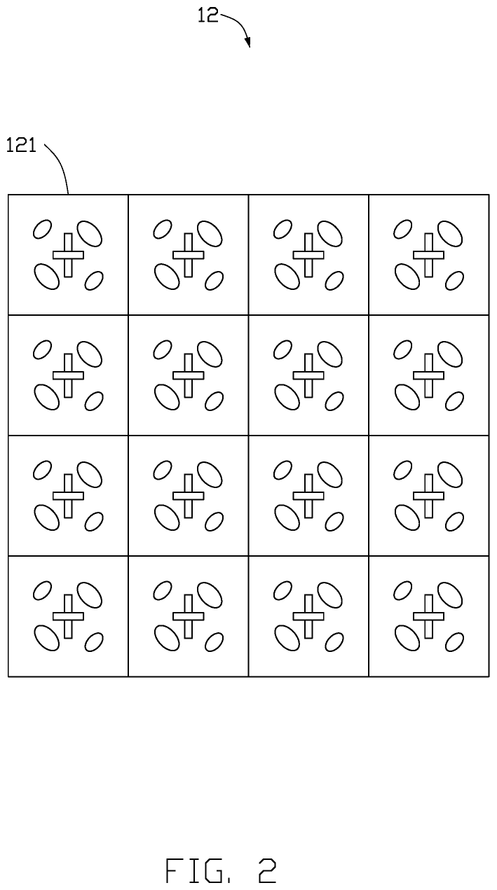

As shown in FIG. 2, the diffracting element 12 is a sheet including at least two diffraction units 121 closely arranged. In the present embodiment, the diffracting element 12 includes a plurality of diffraction units 121 arranged in an array.

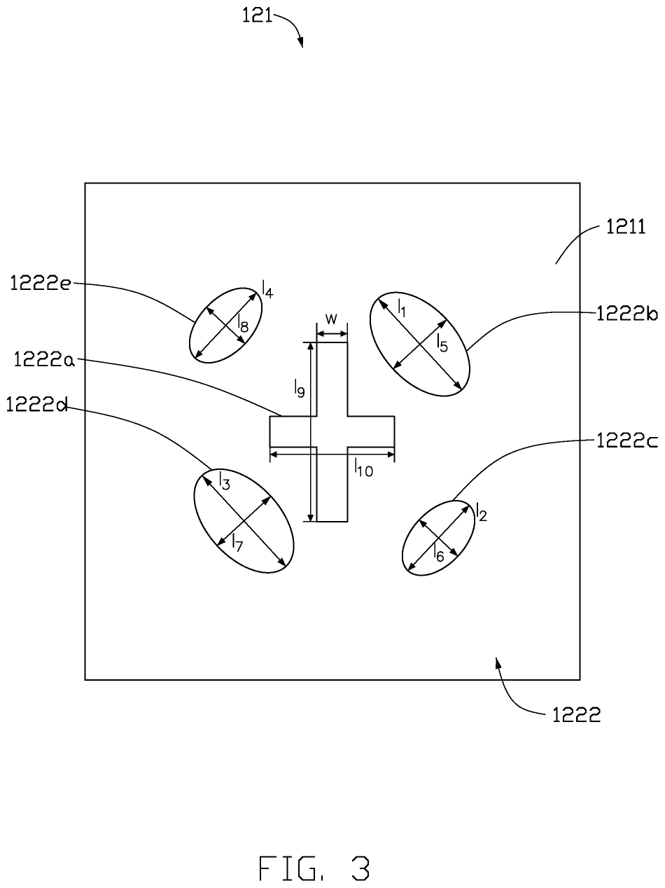

Referring to FIG. 3, each diffraction unit 121 includes a substrate 1211 and a diffraction pattern 1222 formed on the substrate 1211. In this embodiment, the substrate 1211 is a transparent and electrically non-conductive substrate, such as a glass substrate. The substrate 1211 has a square shape having a side length of 2.8 μm and a thickness of 2 The diffraction pattern 1222 has a uniform thickness. In the present embodiment, the diffraction pattern 1222 has a thickness of 2 The diffraction pattern 1222 includes a “+” pattern 1222a and an elliptical pattern 1222b, an elliptical pattern 1222c, an elliptical pattern 1222d, and an elliptical pattern 1222e surrounding the “+” pattern 1222a. The elliptical pattern 1222b and the elliptical pattern 1222d have same shape and size, and the elliptical pattern 1222c and the elliptical pattern 1222e have same shape and size. The elliptical pattern 1222b has a long axis l₁ and a short axis l₅, the elliptical pattern 1222c has a long axis l₂ and a short axis l₆, the elliptical pattern 1222d has a long axis l₃ and a short axis l₇, and the elliptical pattern 1222e has a long axis l₄ and a short axis l₈. The long axis l₁ is equal to the long axis l₃ and is 0.7 microns long, and the long axis l₂ is equal to the long axis l₄ and is 0.5 microns long. The short axis l₅ is equal to the short axis l₇ and is 0.4 microns long, the short axis l₆ is equal to the short axis l₈ and is 0.3 microns long. The “+” pattern 1222a has a long side l₉ and a short side l₁₀, the long side l₉ measures 1 micron, the short side l₁₀ measures 0.7 microns, and a width w of the long side l₉ and the short side l₁₀ both measure 0.175 microns.

Referring to FIG. 1 and FIG. 3, the diffraction pattern 1222 is used to control a form of emission of the detection beams L₂ generated by the diffraction unit 121. The emission form of the detection beams L₂ includes emission angles of the detection beams L₂, projected shapes and beam intensity distribution of the beams on a projection plane parallel to the diffracting element 12. Therefore, it can be understood that a specific structure of the diffraction pattern 1222 in the diffraction unit 121 is determined according to a required emission pattern of the detection beams L₂. The present disclosure does not limit a specific shape of the diffraction pattern 1222 of the diffraction unit 121, and a structure of the diffraction pattern 1222 as shown in FIG. 3 is merely an example.

Diffracting element 12 may produce at least nine levels of diffraction. In the present embodiment, the diffractive element 12 can produce nine diffraction levels, that is, the diffractive element 12 can diffract the light L₁ into nine detection beams L₂.

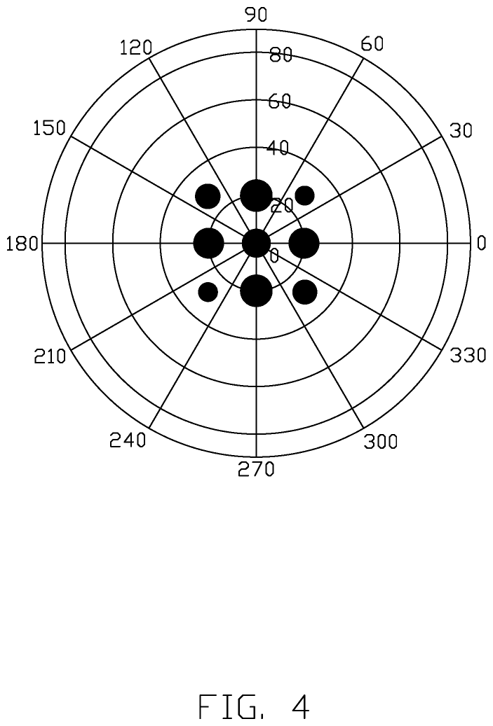

FIG. 4 shows spatial angular distribution of the detection beams L₂ from the diffracting element 12 when the light L₁ is perpendicularly incident on the diffracting element 12.

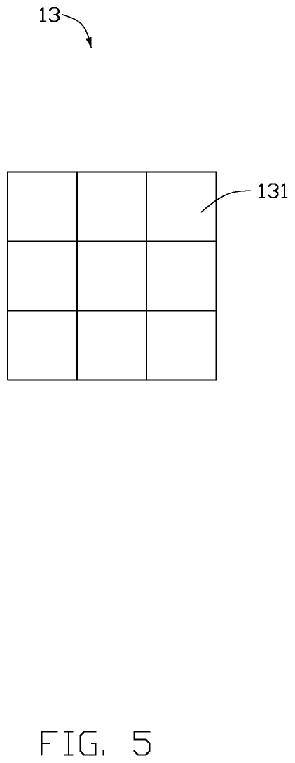

Referring to FIG. 1 and FIG. 5, the beam receiving element 13 is configured to receive a plurality of reflected light beams L₃ reflected by the target object 20. The beam receiving element 13 includes a plurality of pixel regions 131 arranged in an array. Each pixel region 131 is equal in area and receives a reflected light beam L₃ reflected by the target object 20. Therefore, it can be understood that a number of pixel regions 131 in the beam receiving element 13 is greater than or equal to a number of the reflected light beams L₃. In the present embodiment, the number of pixel regions 131 in the beam receiving element 13 is equal to the number of the reflected light beams L3.

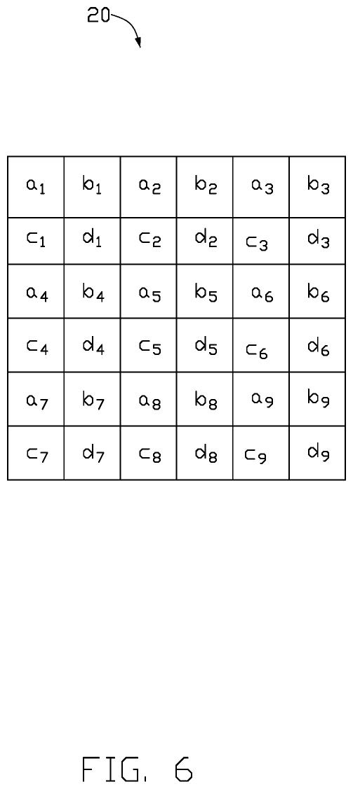

As shown in FIG. 6, at least two scanning point groups are defined on the target object 20, and each scanning point group includes at least two scanning points. In this embodiment, four scanning point groups are defined on the target object 20, and each scanning point group includes nine scanning points. Referring to FIG. 1 and FIG. 6, the scanning point is a single spot on the target object 20 that the detection beam L₂ is irradiating. Specifically, the first scanning point group includes a scanning point a₁, a scanning point a₂, a scanning point a₃, . . . and a scanning point a₉. The second scanning point group includes a scanning point b₁, a scanning point b₂, a scanning point b₃, . . . and a scanning point b₉. The third scanning point group includes a scanning point c₁, a scanning point c₂, a scanning point c₃, . . . and a scanning point c₉, and the fourth scanning point group includes a scanning point d₁, a scanning point d₂, a scanning point d₃, . . . and scanning point d₉.

The laser detecting device 10 is configured to scan the four scanning point groups in a time-division manner, and obtain distances between all of the scanning points in each scanning point group and the beam receiving element 13 in a time-division manner, thereby a complete three-dimensional image of the target object 20 can be obtained. Scanning each scanning point group in a time-division manner is realized by changing an incident angle of the light L₁ incident on the diffracting element 12. That is, when the light L₁ is incident on the diffracting element 12 at different angles of incidence, the detection beams L₂ emitted from the diffracting element 12 scan different scanning point groups on the target object 20.

Referring to FIG. 1, the laser detecting device 10 further includes a scanning controller 15 located between the light source 11 and the diffracting element 12. The scanning controller 15 is located on the optical path of the light L₁, receives the light L₁ and is configured for controlling the incident angle when the light L₁ is incident on the diffracting element 12. In the present embodiment, the scanning controller 15 is a sheet for reflecting the light L₁ onto the diffracting element 12. By changing the angle of inclination between the reflecting sheet (i.e., the scanning controller 15) and the diffracting element 12, the incident angle of the light L₁ on the diffracting element 12 is changed, thereby changing the detection beams L₂ emitted from the diffracting element 12 scanning the scanning points groups on the target object 20.

The central controller 14 is electrically connected to the light source 11, the beam receiving element 13, and the scanning controller 15, and is configured for controlling the light source 11 to be on and off. A time of each reflected light beam L3 received by the beam receiving element 13 is recorded, data processing to obtain a three-dimensional image of the target object 20 is performed, and placement angles of the scanning controller 15 are adjusted. In one embodiment, the central controller 14 is a chip or chipset, in other embodiment, the central controller 14 is a computer.

The working process of the laser detecting device 10 is as follows.

Referring to FIG. 1 and FIG. 6, in a first period, the central controller 14 controls the light source 11 to power on, and the light source 11 emits the light L₁. At this time, the scan controller 15 is at a first placement angle, and receives the light L₁ and the light L₁ is reflected to the diffracting element 12 at a first incident angle. The diffracting element 12 diffracts the light L₁ to generate and emit a plurality of detection beams L₂. In the present embodiment, the diffracting element 12 diffracts the light L₁ to generate and emit nine detection beams L₂. The nine detection beams L₂ scan the scanning point a₁, the scanning point a₂, the scanning point a₃, . . . and the scanning point a₉, respectively. Each of the nine detection beams L₂ scan one of the scanning points and the nine detection beams L₂ are reflected by the target object 20. Thus nine reflected light beams L₃ are generated, in one-to-one correspondence with the detection beams L₂. Each of the pixel regions 131 of the beam receiving element 13 receives one reflected light beam L₃. The central controller 14 is electrically connected to the beam receiving element 13 for recording the times of the pixel regions 131 of the beam receiving element 13 to receive the nine reflected light beams L₃ reflected by the target object 20. Since the central controller 14 records emission time of all the reflected light beams L₃, time differences between the emission times of detection light beams L₂ and the receiving time of the reflected light beams L₃ can be obtained. Propagation speeds of the detection beam L₂ and the reflected light beams L₃ are equal and known. One-half of a product of the propagation speed and the time difference between the emission time of each detection beam L₂ and the receiving time of the reflected light beam L₃ is equivalent to the distance between the one scanning point and the beam receiving element 13, that is, the distance between the one scanning point irradiated and the laser detecting device 10.

Referring to FIG. 1 and FIG. 6, in a second period, the central controller 14 controls the light source 11 to power on, and the light source 11 emits the light L₁. At this time, the scan controller 15 is at a second placement angle, and receives the light L₁ and the light L₁ is reflected to the diffracting element 12 at a second incident angle. The diffracting element 12 diffracts the light L₁ to generate and emit a plurality of detection beams L₂. In the present embodiment, the diffracting element 12 diffracts the light L₁ to generate and emit nine detection beams L₂. The nine detection beams L2 scan the scanning point b₁, the scanning point b₂, the scanning point b₃, . . . and the scanning point b₉ respectively. Each of the nine detection beams L2 scans one of the scanning points and the nine detection beams L₂ are reflected by the target object 20 to generate nine reflected light beams L₃ that is in one-to-one correspondence with the detection beams L₂. The beam receiving element 13 receives the nine reflected light beams L₃, and each of the pixel regions 131 of the beam receiving element 13 receives one reflected light beam L₃. The central controller 14 is electrically connected to the beam receiving element 13 for recording the times of the pixel regions 131 of the beam receiving element 13 receive the nine reflected light beams L₃ reflected by the target object 20. As before, the central controller 14 records an emission time of all the reflected light beams L₃, time differences between the emission times of all the detection light beams L₂ and the receiving time of the beams L₃ can be obtained. The same formula of one-half of a product of the propagation speed and the time differences still applies, thus the distance between the one scanning point of this group and the laser detecting device 10 can be established.

The same processes are followed in the third and fourth periods. In the third period, the diffracting element 12 diffracts the light L₁ to generate and emit nine detection beams L₂. The nine detection beams L2 scan the scanning point c₁, the scanning point c₂, the scanning point c₃, . . . and the scanning point c₉ of the target object 20, respectively. In the fourth period, the diffracting element 12 emit nine detection beams L₂ to scan the scanning point d₁, the scanning point d₂, the scanning point d₃, and the scanning point d₉ of the target object 20, respectively. The specific scanning process is similar to the processes of scanning the scanning point a₁, the scanning point a₂, the scanning point a₃, . . . , the scanning point a₉, the scanning point b₁, the scanning point b₂, the scanning point b₃, . . . and the scanning point b₉, and will not be described again.

After the laser detecting device 10 scans the four scanning point groups in a time division manner, the central controller 14 records the distances between all the scanning points on the target object 20 and the laser detecting device 10, and a complete 3D image of the target object 20 can be obtained according to the above distances. During the above four periods, the central controller 14 always controls the light source 11 to be on, the detection beams L₂ irradiates different scanning point groups of the target object 20 by adjusting placement angles of the scanning controller 15 relative to the diffracting element 12.

It should be understood that a larger number of scanning points are usually defined on the target object 20, thereby improving scanning accuracy. Specifically, increasing the number of scanning points can be realized by changing the structure, material, arrangement, and the like of the diffraction pattern 1222 in the diffracting element 12.

The laser detecting device 10 in this embodiment includes a light source 11, a diffracting element 12, a beam receiving element 13, a central controller 14, and a scanning controller 15. The light source 11 emits light L₁, the light L₁ is diffracted by the diffracting element 12 to form the detection beams L₂, and the detection beams L₂ can simultaneously scan the target object 20, which can effectively improve the scanning efficiency. Further, the target object 20 is defined to have at least two scanning point groups, and the scanning controller 15 is configured for controlling the incident angles of the light L₁ incident on the diffracting element 12. When the incident angles of the light source light L₁ falling on the diffraction element 12 are different, the detection beam L₂ is emitted to scan different scanning point groups on the target object 20. The central controller 14 can change incident angle of the light L₁ on the diffraction element 12 by changing the inclination angle between the scanning controller 15 and the diffraction element 12, such that the scanning point groups on the target object 20 scanned by the detection beam L₂ generated by the diffracting element 12 is changed. Therefore, the central controller 14 and the scanning controller 15 can increase a scanning range of the detection beam L₂.

### Second Embodiment

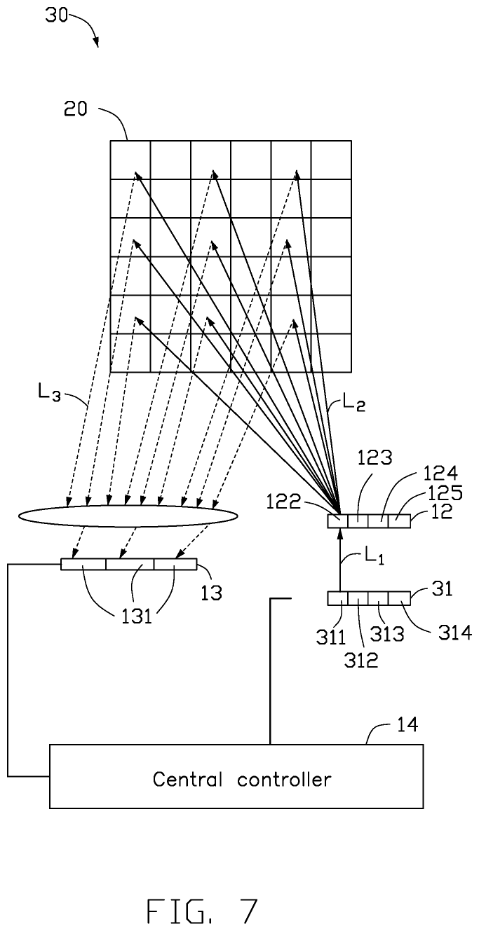

As shown in FIG. 7, a laser detecting device 30 of the second embodiment is substantially the same as the laser detecting device 10 of the first embodiment, the difference is that the laser detecting device 30 includes a light source 11 having a different structure and there is no scanning controller 15.

As shown in FIG. 7, the laser detecting device 30 includes a light source 31, a diffracting element 12, a beam receiving element 13, and a central controller 14 connecting both the light source 11 and the beam receiving element 13. The structures of the diffraction element 12, the beam receiving element 13, and the central controller 14 in the present embodiment are the same as those in the first embodiment.

The light source 31 includes at least two light emitting units. In the present embodiment, the light source 31 includes four light emitting units, which are light emitting units 311-314. In this embodiment, the four light emitting units 311-314 are arranged in a row. In other embodiment, the four light emitting units may be arranged in an array.

The central controller 14 independently controls the four lighting emitting units 311-314 to be on or off. Specifically, the central controller 14 turns on the light emitting unit 311, the light emitting unit 312, the light emitting unit 313, and the light emitting unit 314 in a time-division method. The diffracting element 12 defines at least two diffraction regions in one-to-one correspondence with the light emitting units 311-314. In this embodiment, the diffracting element 12 defines four diffraction regions, which are diffraction regions 122-125. Each of the diffraction regions includes at least one diffraction unit 121 as shown in FIG. 2, and each of the diffraction regions includes a same number of diffraction units 121.

The target object 20 in the present embodiment is the same as the target object 20 in the first embodiment, and has four scanning regions as described in the first embodiment. The four light emitting units are in one-to-one correspondence with the four scanning regions and the four diffraction regions.

The working processes of the laser detecting device 30 will be described below.

Referring to FIG. 6 and FIG. 7, in a first period, the central controller 14 turns on the light emitting unit 311, other light emitting units 312-314 are turned off. The light emitting unit 311 emits the light L₁ toward the diffraction region 122 of the diffracting element 12 to generate and emit nine detection beams L₂. The nine detection beams L2 scan the scanning point a₁, the scanning point a₂, the scanning point a₃, . . . and the scanning point a₉, respectively. Each of the nine detection beams L₂ scans one of the scanning points, the nine detection beams L₂ are reflected by the target object 20 to generate nine reflected light beams L₃ in one-to-one correspondence with the nine detection beams L₂. Each of the pixel regions 131 of the beam receiving element 13 receives one reflected light beam L₃. The central controller 14 is electrically connected to the beam receiving element 13 for recording the times that the pixel regions 131 of the beam receiving element 13 receive the nine reflected light beams L₃ reflected by the target object 20. Since the central controller 14 records a time of emission of all the reflected light beams L₃, time differences between the emission times of all the detection light beams L₂ and the receiving times of the reflected light beams L₃ can be obtained, and propagation speeds of the detection beam L₂ and the reflected light beams L₃ are equal and known. One-half of a product of the propagation speed and the time difference between the emission time of each detection beam L₂ and the receiving time of the reflected light beam L₃ is the distance between the one scanning point and the beam receiving element 13, that is, the distance between the one scanning point and the laser detecting device 30.

In a second period, the central controller 14 turns the light emitting unit 312 on and other light emitting units off. The light emitting unit 312 emits the light L₁ toward the diffraction region 123 of the diffracting element 12 to generate and emit nine detection beams L₂. The nine detection beams L₂ scan the scanning point b₁, the scanning point b₂, the scanning point b₃, . . . and the scanning point b₉, respectively. Each of the nine detection beams L2 scans one of the scanning points and the nine detection beams L₂ are reflected by the target object 20 to generate nine reflected light beams L₃ in one-to-one correspondence with the detection beams L₂. The beam receiving element 13 then functions as before, and the recorded times of emission and receiving enable the calculation of distances as before.

In a third period, the central controller 14 turns the light emitting unit 313 on and other light emitting units off, and in a fourth period the light emitting unit 314 is turned on and the other light emitting units are turned off, the remaining processes being the same and thus not described again.

After the laser detecting device 30 scans the four scanning point groups in a time division manner, the central controller 14 records the distances between all the scanning points on the target object 20 and the laser detecting device 30, and a complete 3D image of the target object 20 can be obtained according to the above distances. During the above four periods, the central controller 14 sequentially powers on the light emitting unit 311, the light emitting unit 312, the light emitting unit 313, and the light emitting unit 314 to change the scanning point group on the target object 20.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A laser detecting device configured to detect an image of a target object, the target object defining at least two scanning point groups, each of the at least two scanning point groups comprising at least two scanning points, the laser detecting device comprising:
a light source configured for emitting light;
a diffracting element configured to receive and diffract light from the light source to generate a plurality of detection beams, the diffracting element being configured to sequentially project the plurality of detection beams to the at least two scanning point groups of the target object;
a beam receiving element configured to receive a plurality of reflected light beams reflected by the target object, and
a central controller electrically connecting to each of the light source and the beam receiving element, and being configured to control powering on and off the light source and process data from the beam receiving element to obtain a three-dimensional image of the target object.

2. The laser detecting device of claim 1, wherein the plurality of detection beams is configured for scanning one of the at least two scanning point groups in a period; and
each of the plurality of detection beams is configured for scanning one of the at least two scanning point groups in the same scanning point group.

3. The laser detecting device of claim 1, wherein the diffracting element comprises a plurality of diffraction units; each of the plurality of diffraction units comprises a transparent substrate and a diffraction pattern formed on the transparent substrate; the diffraction pattern is configured to control an emission form of the plurality of detection beams.

4. The laser detecting device of claim 1, further comprising a scanning controller located between the light source and the diffracting element, wherein the scanning controller is electrically coupled to the central controller; the scanning controller is located on an optical path of the light emitting from the light source and is configured for controlling incident angles of the light incident on the diffracting element.

5. The laser detecting device of claim 4, wherein the incident angles of the light incident on the diffracting element determines which of the at least two scanning point groups is scanned by the plurality of detection beams.

6. The laser detecting device of claim 5, wherein the scanning controller is a reflecting sheet configured for reflecting the light to the diffracting element; the central controller controls an inclination angle between the reflecting sheet and the diffracting element.

7. The laser detecting device of claim 1, wherein the light source comprises at least two light emitting units; the central controller is configured to control each of the at least two lighting emitting units to be turned on or off; the at least two light emitting units corresponds to the at least two scanning point groups one in one.

8. The laser detecting device of claim 7, wherein the central controller is configured to control one of the at least two light emitting units to power on and other of the at least two light emitting units to power off.

9. The laser detecting device of claim 8, wherein the diffracting element comprises at least two diffraction regions corresponding to the at least two light emitting units, respectively; light from one of the at least two light emitting units is irradiated to a corresponding one of the at least two diffraction regions.

10. The laser detecting device of claim 1, wherein the beam receiving element defines a plurality of pixel regions; each of the plurality of pixel regions is capable of receiving one of the plurality of reflected light beams.

11. The laser detecting device of claim 1, wherein the central controller is configured to calculate a distance between each of the scanning points and the beam receiving element based on a time difference between an emission time of each of the plurality of detection beams and an receiving time of the reflected light beam, and obtain an image of the target object.
